(19) United States
(12) Patent Application Publication
(10) Pub. No.: US 2011/0262631 A1
(43) Pub. Date: Oct. 27, 2011

(54) Method For Manufacturing One-Layer Type Capacitive Touch Screen

(75) Inventors: Hee Bum LEE, Gyunggi-do (KR); Kyoung Soo CHAE, Gyunggi-do (KR); Yun Ki HONG, Gyunggi-do (KR); Yong Soo OH, Gyunggi-do (KR); Jong Young LEE, Gyunggi-do (KR)

(73) Assignee: SAMSUNG ELECTRO-MECHANICS CO., LTD., Gyunggi-do (KR)

(21) Appl. No.: 12/838,394

(22) Filed: Jul. 16, 2010

(30) Foreign Application Priority Data
Apr. 23, 2010 (KR) 10-2010-0037998

(51) Int. Cl. B05D 5/12

(52) U.S. Cl. 427/123

(57) ABSTRACT

Disclosed herein is a method for manufacturing a one-layer type capacitive touch screen. The method for manufacturing a one-layer type capacitive touch screen includes: forming a plurality of electrode wirings made of metal in an inactive region of a base substrate; forming a plurality of first electrode patterns made of a conductive polymer and including a first sensing unit and a first connection unit in an active region of the base substrate to connect the electrode wirings; forming an insulating pattern on the plurality of first connection units of the first electrode patterns; and forming a plurality of second electrode patterns including a second sensing unit and a second connection unit and made of the conductive polymer in the active region of the base substrate to connect the electrode wirings and position the second connection unit on the insulating pattern.

### CROSS REFERENCE TO RELATED APPLICATION

This application claims the benefit of Korean Patent Application No. 10-2010-0037998, filed on Apr. 23, 2010, entitled “Method For Manufacturing One-Layer Type Touch Screen”, which is hereby incorporated by reference in its entirety into this application.

### BACKGROUND OF THE INVENTION

1. Technical Field

The present invention relates to a method for manufacturing a one-layer type capacitive touch screen.

2. Description of the Related Art

In general, with development of a mobile communication technology, terminals such as a cellular phone, a PDA, and a navigation apparatus are extending their functions as more various and complicated multimedia providing means such as audio, a moving picture, a wireless Internet web browser, etc. in addition to a simple text information display means. Therefore, a larger display screen is required to be implemented within the limited size of an electronic information terminal; and as a result, a display scheme using a touch screen is further in the limelight.

The touch screen integrates a screen and a coordinate input means to save space in comparison with a key input scheme in the prior art. Therefore, display devices that have been recently developed adopt a display adopting the touch screen in order to further increase a screen size and user convenience.

The touch screen is divided into a resistive touch screen and a capacitive touch screen. As the multi-touch becomes more popular, a research of the capacitive touch screen is in more active progress.

FIG. 1 is a plan view schematically showing a capacitive touch screen in the prior art.

The capacitive touch screen in the prior art is divided into an active region R1 where an electrode pattern is formed and an inactive region R2 where an electrode wiring is formed in a plane. In the capacitive touch screen in the prior art, the electrode pattern formed in the active region R1 is made of a transparent conductive material such as ITO and the electrode wiring formed in the inactive region R2 is made of metal.

In the capacitive touch screen, the electrode pattern is formed on a lower substrate and thereafter, the electrode wiring is formed.

Recently, a research for configuring the electrode pattern by using a conductive polymer has been in progress unlike the electrode pattern made of ITO in the prior art. If the conductive polymer is used for as the electrode pattern, the conductive polymer greatly differs from metal in terms of melting point. Therefore, an importance of heat treatment is being emphasized at the time of manufacturing the capacitive touch screen.

In a method for manufacturing a capacitive touch screen panel in which the electrode pattern is made of the conductive polymer and the electrode wiring is made of the metal, when the electrode pattern is formed and thereafter, the electrode wiring is formed like the prior art, the electrode pattern is again melted and the electrode pattern is thus transformed.

Such a problem markedly occurs in a one-layer type capacitive touch screen in which an X-direction first electrode pattern and a Y-direction second electrode pattern are formed on the same plane.

### SUMMARY OF THE INVENTION

The present invention has been made in an effort to provide a method for manufacturing a one-layer type capacitive touch screen including an electrode pattern made of a conductive polymer and an electrode wiring made of metal, which is capable of preventing the electrode wiring from being transformed by firstly forming the electrode wiring made of the metal in an inactive region of a base substrate and forming the electrode pattern in an active region of the base substrate to be connected with the electrode wiring.

A method for manufacturing a one-layer type capacitive touch screen according to an exemplary embodiment of the present invention includes: forming a plurality of electrode wirings made of metal in an inactive region of a base substrate; forming a plurality of first electrode patterns made of a conductive polymer and including a first sensing unit and a first connection unit in an active region of the base substrate to connect the electrode wirings; forming an insulating pattern on the plurality of first connection units of the first electrode patterns; and forming a plurality of second electrode patterns including a second sensing unit and a second connection unit and made of the conductive polymer in the active region of the base substrate to connect the electrode wirings and position the second connection unit on the insulating pattern.

Further, the method for manufacturing a one-layer type capacitive touch screen further includes, after the forming the second electrode patterns, forming a protective layer to cover the first electrode pattern and the second electrode pattern.

In addition, at the forming the first electrode patterns and the forming the second electrode patterns, the first electrode patterns and the second electrode patterns are formed by an inkjet printing method.

Moreover, at the forming the insulating pattern, the insulating pattern is formed to cover the side and the top of the first connection unit.

Besides, at the forming the insulating pattern, the insulating pattern is formed by the inkjet printing method.

Further, at the forming the first electrode patterns and the forming the second electrode patterns, the conductive polymer is any one of polythiophene, polypyrrole, polyaniline, polyacetylene, and polyphenylene polymers.

A method for manufacturing a one-layer type capacitive touch screen according to another embodiment of the present invention includes: forming a plurality of electrode wirings made of metal in an inactive region of a base substrate; forming a plurality of first connection units made of a conductive polymer in an active region of the base substrate; forming an insulating pattern on the first connection units; and forming a plurality of first sensing units made of the conductive polymer, connected with the electrode wires, and connected with the first connection units, a plurality of second connection units made of the conductive polymer and positioned on the insulating pattern, and a plurality of second sensing units made of the conductive polymer and connected with the electrode wirings.

Further, at the forming the first sensing units, second connection units, and second sensing units, the first sensing units, the second connection units, and the second sensing units are all formed by an inkjet printing method.

In addition, at the forming the first sensing units, second connection units, and second sensing units, after the second connection units are formed on the insulating pattern, both the first sensing units and the second sensing units are formed by the inkjet printing method.

Besides, the method for manufacturing a one-layer type capacitive touch screen further includes, after the forming the first sensing units, second connection units, and second sensing units, forming a protective layer to cover the first sensing units, the second connection units, and the second sensing units.

### BRIEF DESCRIPTION OF THE DRAWINGS

FIG. 1 is a plan view schematically showing a capacitive touch screen in the prior art;

FIG. 2 is a perspective view of a one-layer type capacitive touch screen manufactured according to the present invention;

FIGS. 3 to 12 are plan views and cross-sectional views showing a manufacturing process of a touch screen according to a first preferred embodiment of the present invention; and

FIGS. 13 to 22 are plan views and cross-sectional views showing a manufacturing process of a touch screen according to a second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention may obscure the gist of the present invention, the detailed description will be omitted.

Hereinafter, the preferred embodiments of the present invention will be described in detail with reference to the accompanying drawings.

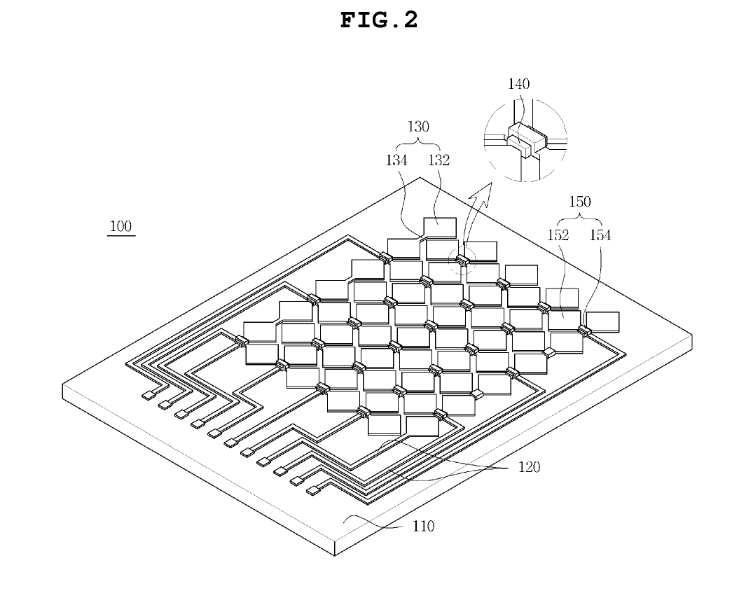

FIG. 2 is a perspective view of a one-layer type capacitive touch screen manufactured according to the present invention. Hereinafter, the one-layer type capacitive touch screen to which a manufacturing method of the present invention can be applied will be described.

The one-layer type capacitive touch screen 100 includes a plurality of electrode wirings 120 formed in an inactive region (edge region) of a base substrate 110, and a first electrode pattern 130, an insulating pattern 140, and a second electrode pattern 150 formed in an active region.

The base substrate 110 as a transparent member may adopt a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylenenaphatalenedicarboxylate (PEN), polycarbonate (PC), polyethersulfone (PES), polyimide (PI), polyvinylalcohol (PVA), cyclic olefin copolymer (COC), stylene polymer, polyethylene, polypropylene, etc. and is not particularly limited.

In addition, the plurality of electrode wirings 120 are formed in the inactive region of the base substrate 110 and some of them are connected with the first electrode pattern 130 and the rest is connected with the second electrode pattern 150. At this time, the inactive region as a periphery of the base substrate 110 represents a region through which an image does not passes.

The electrode wirings 120 are made of metal (e.g., silver (Ag)) paste. The electrode wirings 120 extend to the inactive region and their distal ends are collected at an edge of the base substrate 110. As such, the edge region at which the distal ends of the electrode wirings 120 are collected are referred to as a connection unit and the connection unit is connected with an FPCB (not shown) to transfer a change of capacitance of the electrode pattern to a capacitance sensor (not shown).

Further, the plurality of first electrode patterns 130 connected with the electrode wiring 120 are formed in the active region of the base substrate 110. The first electrode pattern 130 is made of a conductive polymer and the conductive polymer may adopt polythiophene, polypyrrole, polyaniline, polyacetylene, polyphenylene polymers, etc. as organic compounds. In particular, among the polythiophene-based compounds, a PEDOT/PSS compound is most preferable and one or more kinds of compounds among the organic compounds may be mixed and used. Further, when a carbon nanotube, etc. are additionally mixed, conductivity can be improved.

The plurality of first electrode patterns 130 are, in parallel, formed in a first direction (Y direction) and the first electrode pattern 130 has a shape in which a plurality of first sensing units 132 and a plurality of first connection units 134 are repetitively formed. At this time, the first sensing unit 132 is a part measuring the change of the capacitance when a user's hand touches the touch screen and the first connection unit 134 is a part connecting the plurality of first sensing units 132.

Meanwhile, in FIG. 2, the first sensing unit 132 has a diamond shape, but it is just exemplary and may be modified and implemented.

In addition, the insulating pattern 140 is formed on the first connection unit 134 of the first electrode pattern 130. The insulating pattern 140 is positioned between the first connection unit 134 of the first electrode pattern 130 and a second connection unit 154 of the second electrode pattern 150 and disables the first electrode pattern 130 and the second electrode pattern 150 described below to contact with each other. The insulating pattern 140 may be made of a transparent plastic material.

Further, the plurality of second electrode patterns 150 are formed on the same plane as the first electrode pattern 130 and in parallel, formed in a second direction (X direction). The second electrode pattern 150 is made of the same material as the first electrode pattern 130 and has the same shape as the first electrode pattern 130.

However, the second electrode pattern 150 is not connected with and the first electrode pattern 130 and electrically separated from the first electrode pattern 130. Further, the second connection unit 154 of the second electrode pattern 150 is positioned on the above-mentioned insulating pattern 140 and connects adjacent second sensing units 152 formed on the base substrate 110 to each other.

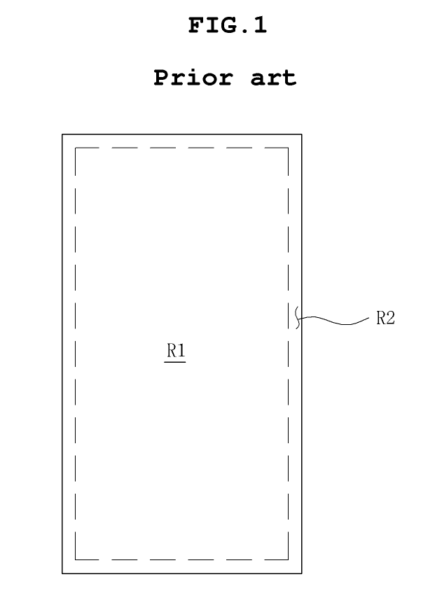

In addition, although not shown in FIG. 1, the one-layer type capacitive touch screen further includes a protective layer 160 formed to cover the first electrode pattern 130 and the second electrode pattern 150 formed on the first base substrate 110.

The protective layer 160 may be made of the same material as the above-mentioned base substrate 110, forms a contact surface touched by a user's finger, and may be coupled by an optical adhesive.

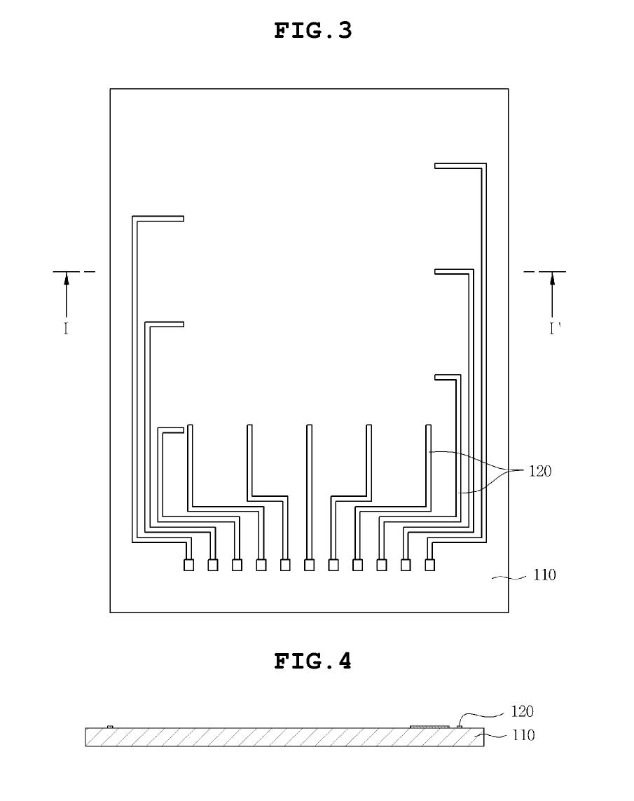

FIGS. 3 to 10 are plan views and cross-sectional views showing a manufacturing process of a touch screen according to a first preferred embodiment of the present invention. Hereinafter, a method for manufacturing a one-layer type capacitive touch screen according to an exemplary embodiment of the present invention will be described.

First, as shown in FIGS. 3 and 4, a plurality of electrode wirings 120 made of metal are formed in an inactive region of a base substrate 110. A photolithography method, an inkjet printing method, and a gravure printing method may be adopted.

The forming step of the electrode wiring 120 is performed at high temperature because the electrode wiring 120 is made of the metal. Since a manufacturing process of a touch screen is performed from a high-temperature process to a low-temperature process by performing the forming step of the electrode wiring 120 earlier than a step of forming an electrode pattern 130 which is the low-temperature process, thermal stability is increased and the electrode pattern 130 can be prevented from being damaged.

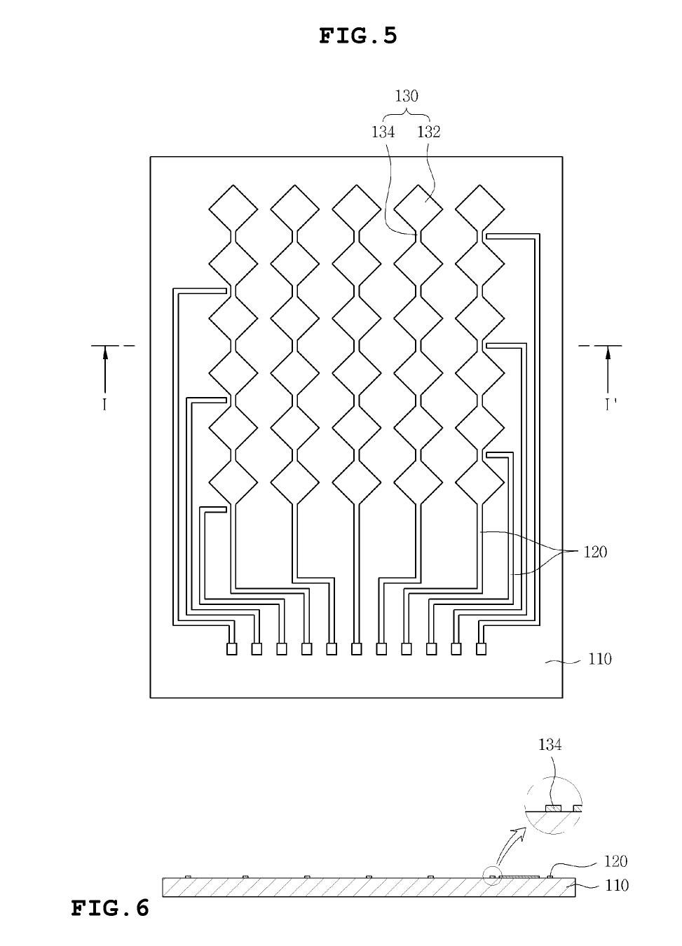

Next, as shown in FIGS. 5 and 6, the plurality of first electrode patterns 130 made of a conductive polymer are formed in an active region of the base substrate 110 to be connected with the electrode wiring 120. At this time, although the first electrode pattern 130 is formed in a Y direction, it is just exemplary and the first electrode pattern 130 is formed in a direction vertical to a second electrode pattern 150 described below, such that the capacitive touch screen is manufactured.

At this time, the first electrode pattern 130 is preferably formed by the inkjet printing method. Conductive polymer ink is charged in an inkjet device, which performs printing on the base substrate 110 to have a first sensing unit 132 and a first connection unit 134. A laser method or a photolithography method in the prior art is performed by forming and patterning an electrode film. Since the laser method or the photolithography method is performed by a high-temperature process, forming the conductive polymer sensitive to heat by the inkjet printing method can improve reliability of the electrode pattern.

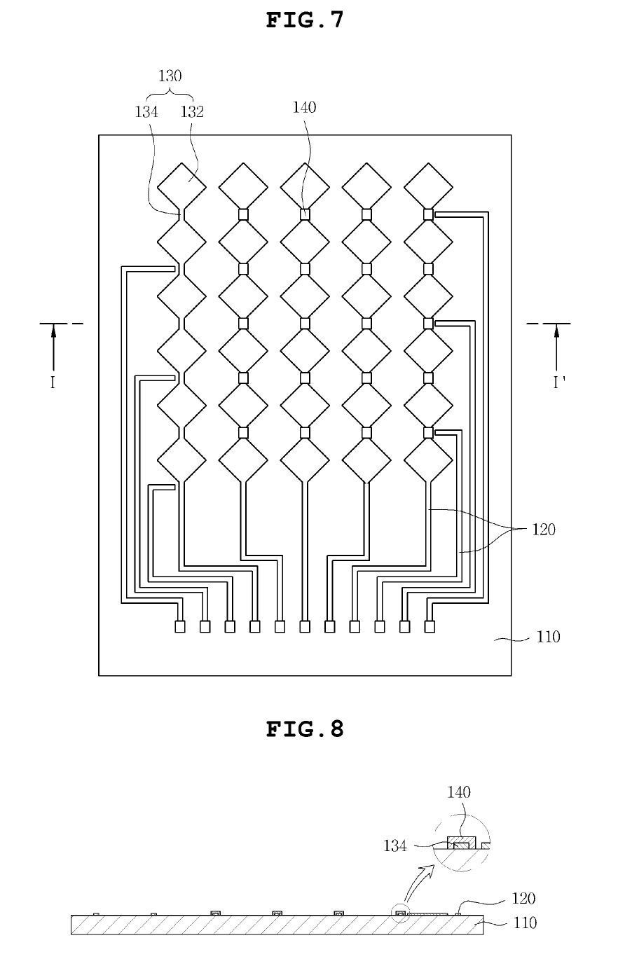

In addition, as shown in FIGS. 7 and 8, an insulating pattern 140 is formed on the first connection unit 134 of the first electrode pattern 130.

In the one-layer type capacitive touch screen, since a short may occur at a connection portion where the first electrode pattern and the second electrode pattern intersect when the first electrode pattern and the second electrode pattern are positioned on the same plane, the insulating pattern 140 is formed on the first connection unit 134 of the first electrode pattern 130 to prevent the short.

At this time, when the insulating pattern 140 is formed by the inkjet printing method, the insulating pattern 140 may be formed at an accurate location by using a predetermined amount of insulating material.

In addition, the insulating pattern 140 is preferably formed to cover the side and the top of the first connection unit 134. The insulating pattern 140 having such a shape prevents the first connection unit 134 from being exposed to the outside in order to prevent the short that occurs when the second electrode pattern 150 is formed.

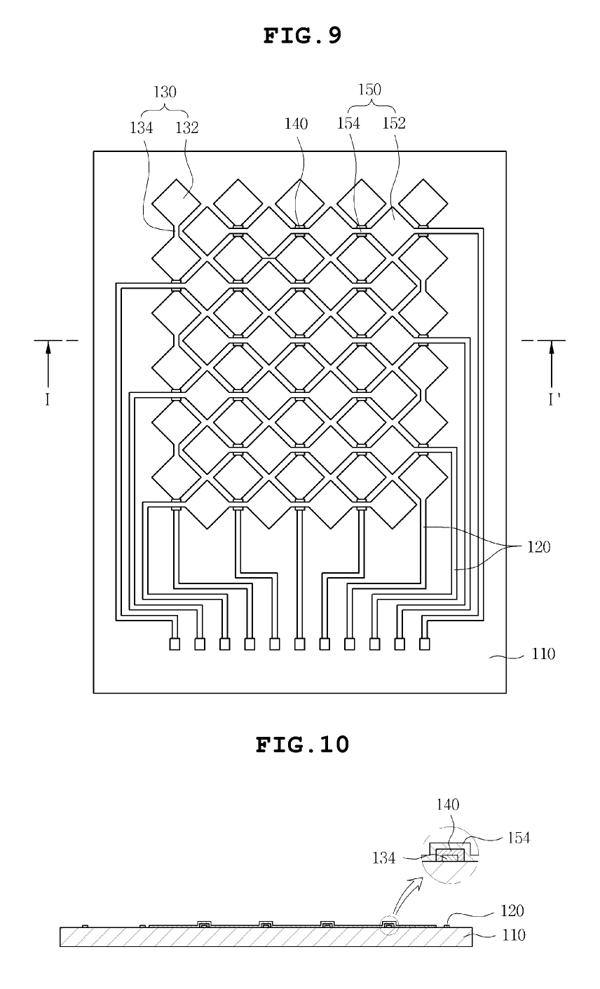

Next, as shown in FIGS. 9 and 10, the plurality of second electrode patterns 150 made of the conductive polymer are formed on the base substrate 110.

A second sensing unit 152 of the second electrode pattern 150 is formed in a residual space formed by the first sensing unit 132 of the first electrode pattern 130, and the second connection unit 154 connecting the second sensing unit 152 is formed on the insulating pattern and is not connected with the first electrode pattern 130.

Further, one end of each of the plurality of second electrode patterns 150 is connected with the electrode wiring 120 and is, in parallel, formed in an X direction.

At this time, it is preferable that in the second electrode pattern 150, the second sensing unit 152 and the second connection unit 154 are integrally formed by the inkjet printing method. The second electrode pattern 150 formed as above has the same advantage as the first electrode pattern 130 formed by the inkjet printing method.

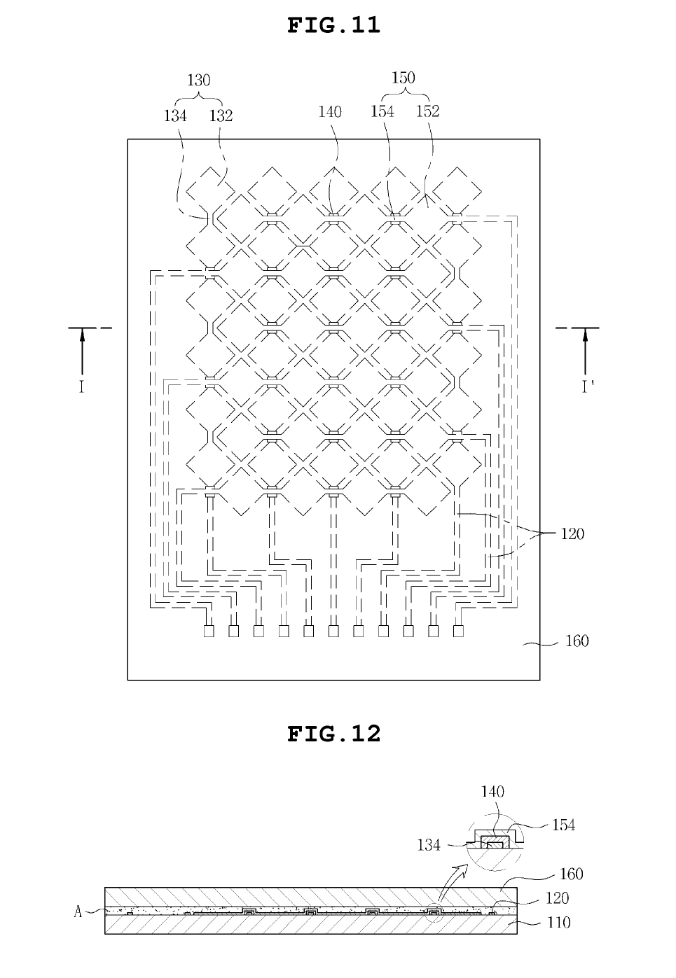

In addition, as shown in FIGS. 11 and 12, a protective layer 160 is formed to cover the first electrode pattern 130 and the second electrode pattern 150 formed on the first base substrate 110. When the protective layer 160 is configured by a glass substrate, the protective layer 160 may be bonded by an optical adhesive A and when the protective layer 160 is configured by a film substrate, the protective layer 160 may be formed by a laminating method.

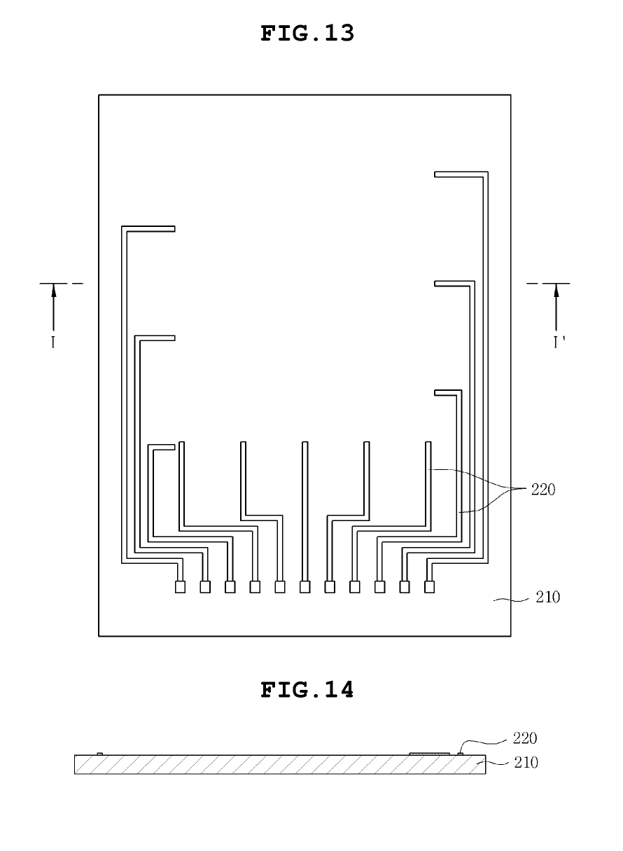

FIGS. 13 to 20 are plan views and cross-sectional views showing a manufacturing process of a touch screen according to a second preferred embodiment of the present invention. Hereinafter, a method for manufacturing a one-layer type capacitive touch screen according to an exemplary embodiment of the present invention will be described. However, detailed description of the same process as the manufacturing process described with reference to FIGS. 3 to 12 will be omitted.

First, as shown in FIGS. 13 and 14, a plurality of electrode wirings 220 made of metal are formed in an inactive region of a base substrate 210.

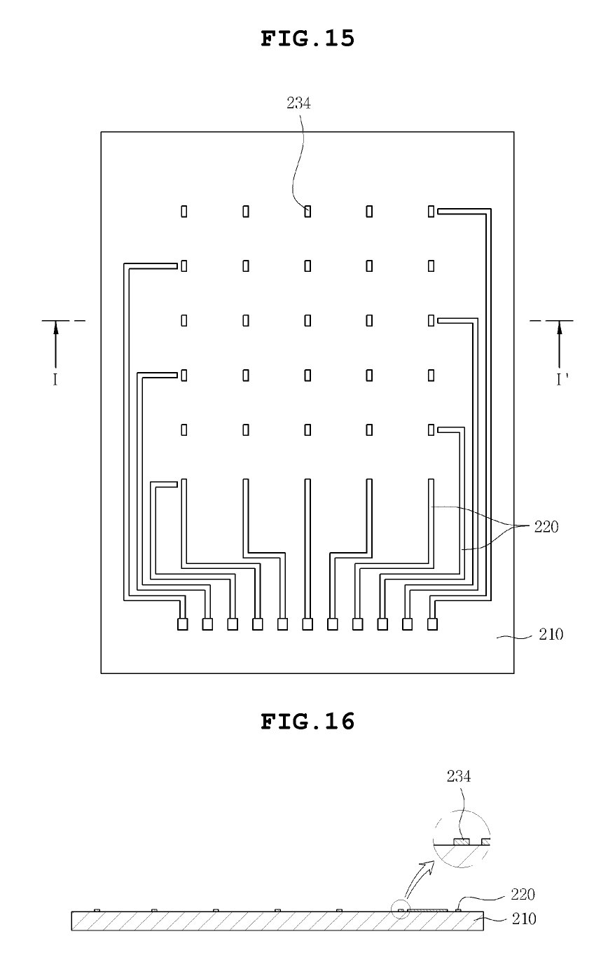

Next, as shown in FIGS. 15 and 16, a plurality of connection units 234 are formed in an active region of the base substrate 210. The first connection units 234 are preferably performed by an inkjet printing method. The first connection units 234, which are made of a conductive polymer, are also performed at low temperature.

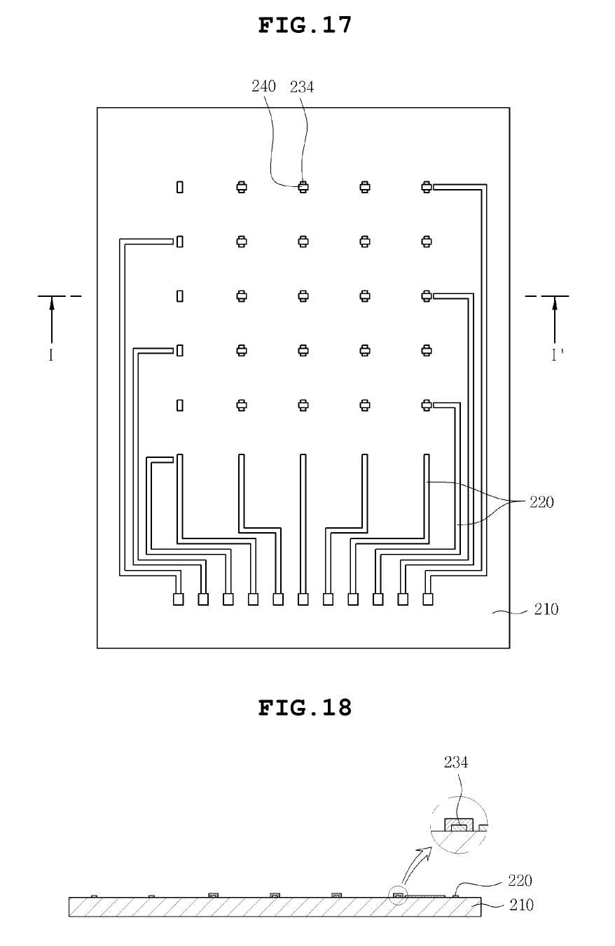

In addition, as shown in FIGS. 17 and 18, an insulating pattern 240 is formed on the plurality of first connection units 234. The insulating pattern 240 may be formed by the inkjet printing method. The first insulating pattern 240 intersects the first connection unit 234 and is formed in an X direction to expose both Y-direction ends of the first connection unit 234.

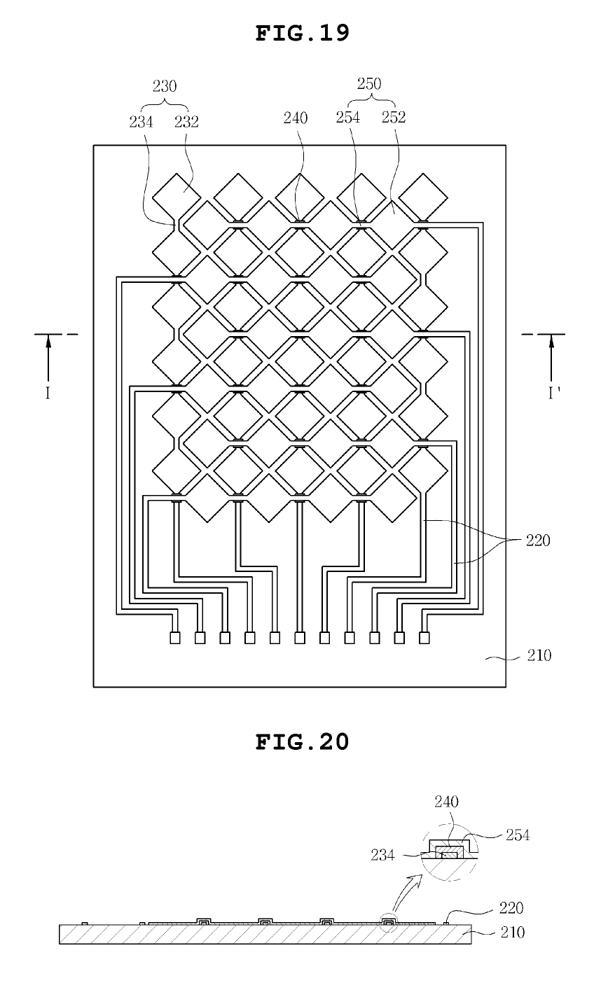

Thereafter, as shown in FIGS. 19 and 20, a first sensing unit 232, a second sensing unit 252, and a second connection unit 254 are formed on the base substrate 210.

The first sensing unit 232 is made of the conductive polymer and is formed in the Y direction to connect the first connection unit 234. Consequently, the first sensing unit 232 and the first connection unit 234 are repetitively formed, such that the first electrode pattern 230 is connected with the electrode wiring 220 at one end thereof.

The second sensing unit 252 and the second connection unit 254 are also made of the conductive polymer. The second connection unit 254 is disposed on the insulating pattern 240 and the second sensing unit 252 is disposed in an empty space formed by the first sensing unit 232. As a result, the second connection unit 254 and the second sensing unit 252 are repetitively formed in the X direction so as to form a second electrode pattern 250.

At this time, it is preferable that the first sensing unit 232, the second sensing unit 252, and the second connection unit 254 are all formed by the inkjet printing method. The printing is performed in the X or Y direction. All electrode patterns required for the one-layer type capacitive touch screen are formed by one-time printing, such that the manufacturing process becomes simple.

Further, after the second connection unit 254 is formed on the insulating pattern 240, both the first sensing unit 232 and the second sensing unit 252 may be simultaneously formed by the inkjet printing method. A bridge region having a complicated shape is accurately and minutely formed by preferentially forming the second connection unit 254 on the insulating pattern 240 and the first and second sensing units 232 and 252 disposed on the same plane are formed so as to form an accurate pattern and prevent a short between the first electrode pattern 230 and the second electrode pattern 250.

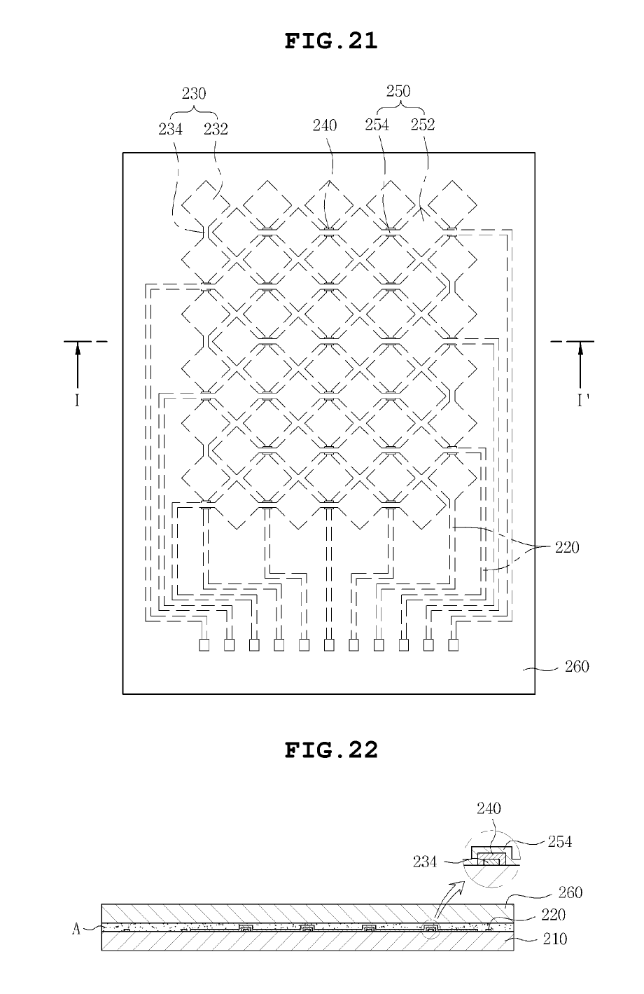

In addition, as shown in FIGS. 21 and 22, a protective layer 260 is formed to cover the first electrode pattern 230 and the second electrode pattern 250 formed on the base substrate 210.

According to the present invention, it is possible to manufacture a one-layer type capacitive touch screen without damaging an electrode pattern made of a conductive polymer having a low melting point by performing an electrode wiring forming process which is a high-temperature process and thereafter, performing an electrode pattern forming process which is a low-temperature process.

Further, it is possible to manufacture the one-layer type capacitive touch screen that can save an insulating material by forming an insulating pattern in only a connection portion of the electrode pattern, has a simple manufacturing process, and has a light weight.

In addition, since the electrode pattern is made of the conductive polymer, the one-layer type capacitive touch screen can be adopted as a touch screen in a flexible display field.

Besides, it is possible to easily form an electrode pattern having a complicated shape by forming the electrode pattern in an inkjet printing method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A method for manufacturing a one-layer type capacitive touch screen, comprising:
forming a plurality of electrode wirings made of metal in an inactive region of a base substrate;
forming a plurality of first electrode patterns made of a conductive polymer and including a first sensing unit and a first connection unit in an active region of the base substrate to connect the electrode wirings;
forming an insulating pattern on the plurality of first connection units of the first electrode patterns; and
forming a plurality of second electrode patterns including a second sensing unit and a second connection unit and made of the conductive polymer in the active region of the base substrate to connect the electrode wirings and position the second connection unit on the insulating pattern.

2. The method for manufacturing a one-layer type capacitive touch screen as set forth in claim 1, further comprising, after the forming the second electrode patterns, forming a protective layer to cover the first electrode pattern and the second electrode pattern.

3. The method for manufacturing a one-layer type capacitive touch screen as set forth in claim 1, wherein at the forming the first electrode patterns and the forming the second electrode patterns, the first electrode patterns and the second electrode patterns are formed by an inkjet printing method.

4. The method for manufacturing a one-layer type capacitive touch screen as set forth in claim 1, wherein at the forming the insulating pattern, the insulating pattern is formed to cover the side and the top of the first connection unit.

5. The method for manufacturing a one-layer type capacitive touch screen as set forth in claim 1, wherein at the forming the insulating pattern, the insulating pattern is formed by the inkjet printing method.

6. The method for manufacturing a one-layer type capacitive touch screen as set forth in claim 1, wherein at the forming the first electrode patterns and the forming the second electrode patterns, the conductive polymer is any one of polythiophene, polypyrrole, polyaniline, polyacetylene, and polyphenylene polymers.

7. A method for manufacturing a one-layer type capacitive touch screen, comprising:
forming a plurality of electrode wirings made of metal in an inactive region of a base substrate;
forming a plurality of first connection units made of a conductive polymer in an active region of the base substrate;
forming an insulating pattern on the first connection units; and
forming a plurality of first sensing units made of the conductive polymer, connected with the electrode wirings, and connected with the first connection units, a plurality of second connection units made of the conductive polymer and positioned on the insulating pattern, and a plurality of second sensing units made of the conductive polymer and connected with the electrode wirings.

8. The method for manufacturing a one-layer type capacitive touch screen as set forth in claim 7, wherein at the forming the first sensing units, second connection units, and second sensing units, the first sensing units, the second connection units, and the second sensing units are all formed by an inkjet printing method.

9. The method for manufacturing a one-layer type capacitive touch screen as set forth in claim 7, wherein at the forming the first sensing units, second connection units, and second sensing units, after the second connection units are formed on the insulating pattern, both the first sensing units and the second sensing units are formed by the inkjet printing method.

10. The method for manufacturing a one-layer type capacitive touch screen as set forth in claim 7, further comprising, after the forming the first sensing units, second connection units, and second sensing units, forming a protective layer to cover the first connection units, the first sensing units, the second connection units, and the second sensing units.
